(19) United States
(12) Patent Application Publication
(10) Pub. No.: US 2024/0190113 A1
(43) Pub. Date: Jun. 13, 2024

(54) ANTIBACTERIAL CUPRIC-ION-FIBER CORRECTIVE SHOE-PAD AND MANUFACTURING METHOD THEREOF

(71) Applicant: Jet Crown International Co., Ltd., Tainan City (TW)

(72) Inventors: Edmund Wang, Tainan City (TW); Yung Lin Wang, Tainan City (TW); Jessica Wang, Tainan City (TW)

(21) Appl. No.: 18/338,359

(22) Filed: Jun. 21, 2023

(30) Foreign Application Priority Data
Dec. 13, 2022 (TW) 111147839

(51) Int. Cl. B32B 27/18; B32B 3/26; B32B 5/02; B32B 37/10

(52) U.S. Cl. CPC B32B 27/18; B32B 3/263; B32B 5/022; B32B 37/10; B32B 2250/04; B32B 2307/7145; B32B 2307/744; B32B 2309/02; B32B 2311/12; B32B 2367/00; B32B 2437/02

(57) ABSTRACT

An antibacterial cupric-ion-fiber corrective shoe-pad and a manufacturing method thereof are disclosed. The shoe-pad is manufactured by staking a cupric-ion-fiber face layer, a shock-absorbing layer, a support layer, and an antibacterial and anti-slip layer in order, and laminating the layers into a laminate in a mold through hot pressing, wherein different temperatures are applied to the shoe-pad during the hot pressing to form support zones as well as a heel enclosure and its extension segment that enclose rear and outer sides of the shoe-pad, thereby providing a human foot with protective and supportive effects such as shock absorption and pressure distribution. When the shoe-pad is placed into a shoe, the cupric-ion-fiber face layer when contacting the human foot provides long-lasting antibacterial and anti-odor effects, and the bottommost antibacterial and anti-slip layer prevents the shoe-pad from undesirably shifting in the shoe, thereby enhancing user comfort.

### BACKGROUND OF THE INVENTION

### 1. Technical Field

The present invention relates to shoe-pads, and more particularly to an antibacterial cupric-ion-fiber corrective shoe-pad and a manufacturing method thereof.

### 2. Description of Related Art

In the prior art, Taiwan Patent No. I377919, titled “Biomechanics medical corrective shoe-pad with far infrared ray energy fibers” and granted to the same inventor of the present invention (herein incorporated by reference in its entirety and hereinafter referred to as “the prior-art shoe-pad”) has disclosed a shoe-pad made by stacking an antibacterial cloth layer, a foam layer, a far-infrared light-wave energy fiber layer, a polyethylene layer, and a bacteriostatic cloth-layer in order; and laminating the stack of the antibacterial cloth layer, the foam layer, the far-infrared light-wave energy fiber layer, the polyethylene layer, and the bacteriostatic cloth-layer in a mold into a laminate through hot pressing, wherein the hot pressing is performed at different temperatures for the peripheral area, the support area, and the curve area of the shoe-pad, so that the periphery of the shoe-pad is combined firmly at high hot-pressing temperatures, while the support area, and the curve area are formed to be beneficial in terms of ergonomics and foot reflexology, thereby having shock-absorbing and pressure-distributing advantages and providing protective and supportive effects to human feet.

The prior-art shoe-pad is considered favorable to blood circulation throughout muscle micro-vessels in human feet. However, it provides no solution to excessive growth of fungus on a foot in the humid and warm environment inside a shoe, and leaves foot fungus spreading into living spaces and contaminating bedding, furniture, indoor shoes, and furniture textiles to endanger human health and immunity. In addition, the prior-art shoe-pad is found to be less effective in shock absorption and pressure distribution due to insufficient resilience, which is responsible for muscle fatigue under the ground reaction force, particularly when users stand on or walk with the shoe-pad for long periods. Moreover, the support areas provided on the prior-art shoe-pad are imperfect in terms of profile and shape, making it incapable of fully fit and brace foot arches, so its pressure-distributing effect need to be improved.

To address the aforementioned issues of the prior-art shoe-pad in use, the inventor devises corresponding solutions based on years of experience and expertise in shoe-pad design and manufacturing and herein proposes the present invention.

### SUMMARY OF THE INVENTION

The primary objective of the present invention is to provide an antibacterial cupric-ion-fiber corrective shoe-pad and a manufacturing method thereof that have layers with different functions laminated firmly to provide human feet with long-lasting antibacterial and anti-odor effects in addition to good protection and support and to achieve prevention of undesirably shifting in a shoe.

To accomplish the foregoing objectives of the present invention, the inventor devises an antibacterial cupric-ion-fiber corrective shoe-pad, which comprises a cupric-ion-fiber face layer, a shock-absorbing layer, a support layer, and an antibacterial and anti-slip layer, wherein the cupric-ion-fiber face layer, the shock-absorbing layer, the support layer, and the antibacterial and anti-slip layer are vertically stacked in order and laminated into a laminate through hot pressing.

The shoe-pad as described previously further comprises a plurality of support zones formed thereon, a heel enclosure raised upward from a rear end of the shoe-pad, and an extension segment located at an outer side of the shoe-pad and connected to the heel enclosure.

In the shoe-pad as described previously, the heel enclosure has a height of 15 mm.

In the shoe-pad as described previously, the plural support zones include a transverse arch support zone, a medial longitudinal arch support zone, a lateral longitudinal arch support zone, a calcaneus support zone, and a transverse-longitudinal support zone located to correspond to a transverse arch portion, a medial longitudinal arch portion, a lateral longitudinal arch portion, a calcaneus portion, and a transverse-longitudinal arch portion of a human foot.

The shoe-pad as described previously further comprises a bottom formed with a longitudinal support curve that longitudinally extends across the transverse arch support zone, the medial longitudinal arch support zone, and the calcaneus support zone, and a transverse support curve that transversely extends across the medial longitudinal arch support zone and the transverse-longitudinal support zone.

A manufacturing method of the shoe-pad as described previously comprises steps of:

A. Stacking: stacking a cupric-ion-fiber face layer, a shock-absorbing layer, a support layer, and an antibacterial and anti-slip layer, each preformed to have a shape of the shoe-pad, vertically in an order from top to bottom;

B. placing the cupric-ion-fiber face layer, the shock-absorbing layer, the support layer, and the antibacterial and anti-slip layer that have been stacked into a shoe-pad mold and performing hot pressing thereon, so as to laminate the cupric-ion-fiber face layer, the shock-absorbing layer, the support layer, and the antibacterial and anti-slip layer into a laminate during the hot pressing; and

C. Finishing: finishing the laminate of the cupric-ion-fiber face layer, the shock-absorbing layer, the support layer, and the antibacterial and anti-slip layer into the shoe-pad.

In the method of the shoe-pad as described previously, the shoe-pad is further formed with a plurality of support zones, a heel enclosure raised upward from a rear end of the shoe-pad, and an extension segment located at an outer side of the shoe-pad and connected to the heel enclosure.

In the method of the shoe-pad as described previously, the plural support zones include a transverse arch support zone, a medial longitudinal arch support zone, a lateral longitudinal arch support zone, a calcaneus support zone, and a transverse-longitudinal support zone located to correspond to a transverse arch portion, a medial longitudinal arch portion, a lateral longitudinal arch portion, a calcaneus portion, and a transverse-longitudinal arch portion of a human foot.

In the method of the shoe-pad as described previously, the hot pressing for the transverse arch support zone, the medial longitudinal arch support zone, the lateral longitudinal arch support zone, and the calcaneus support zone is performed at a temperature of 70° C., and the hot pressing for the transverse-longitudinal support zone is performed at a temperature of 100° C.

In the method of the shoe-pad as described previously, the hot pressing for the heel enclosure and the extension segment connected thereto is performed at a temperature of 165° C.

Thereby, in virtue of the plural support zones formed on the shoe-pad as well as the heel enclosure and its extension segment provided at the rear end and outer side of the shoe-pad, when the shoe-pad is placed in a shoe, it provides a human foot wearing the shoe for standing or moving around with protective and supportive effects such as shock absorption and pressure distribution. Besides, when contacting a human foot, the cupric-ion-fiber face layer provides long-lasting antibacterial and anti-odor effects. Additionally, the bottommost antibacterial and anti-slip layer prevents the shoe-pad from undesirably shifting in the shoe, thereby enhancing user comfort.

### BRIEF DESCRIPTION OF THE DRAWINGS

FIG. 1 is an exploded view of a shoe-pad of the present invention;

FIG. 2 is a perspective view of the shoe-pad of the present invention;

FIG. 3 is a close-up cross-sectional view of the shoe-pad of the present invention;

FIG. 4 is a top view of the shoe-pad of the present invention;

FIG. 5 is a cross-sectional view of the shoe-pad of the present invention;

FIG. 6 is another cross-sectional view of the shoe-pad of the present invention;

FIG. 7 is still another cross-sectional view of the shoe-pad of the present invention; and

FIG. 8 is an applied view of the shoe-pad of the present invention.

### DETAILED DESCRIPTION OF THE INVENTION

For further illustrating the technical means and effects of the present invention, the following description is set forth as below with reference to the accompanying drawings.

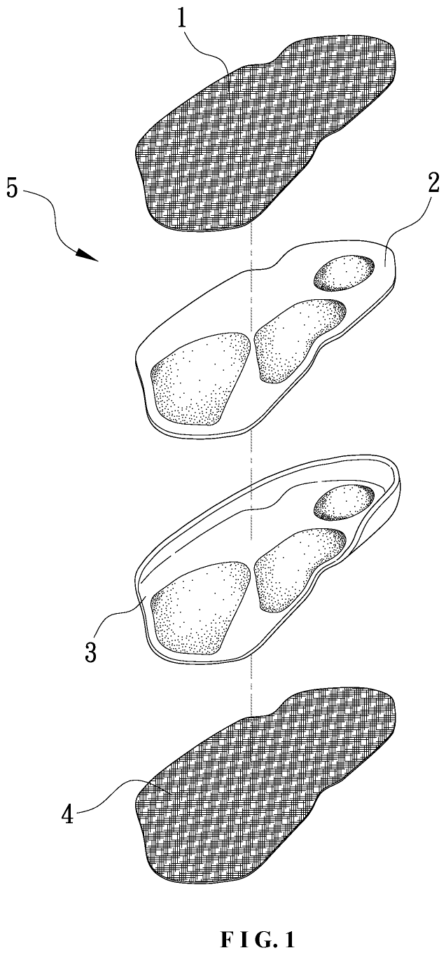

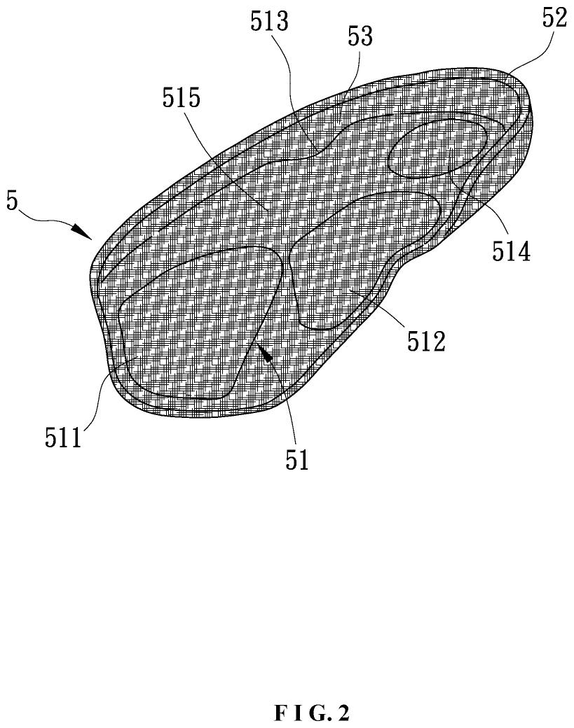

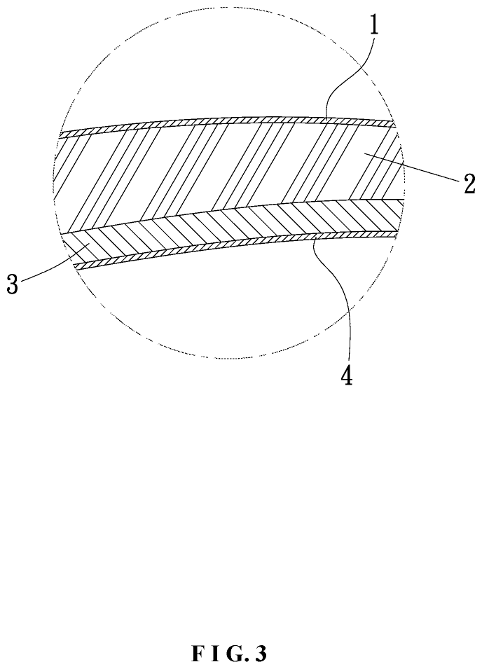

FIG. 1 through FIG. 3 illustrates a manufacturing method for making an antibacterial cupric-ion-fiber corrective shoe-pad according to the present invention. The manufacturing method comprises the following steps.

The first step is stacking (A), which involves stacking a cupric-ion-fiber face layer (1), a shock-absorbing layer (2), a support layer (3), and an antibacterial and anti-slip layer (4), each preformed to have a shape of the shoe-pad, vertically in an order from top to bottom, wherein the shock-absorbing layer (2) is made of a medical foaming material, and the support layer (3) is made of a high-density polyethylene material, while the antibacterial and anti-slip layer(4) is made of anti-slip non-woven fabric containing an antibacterial substance;

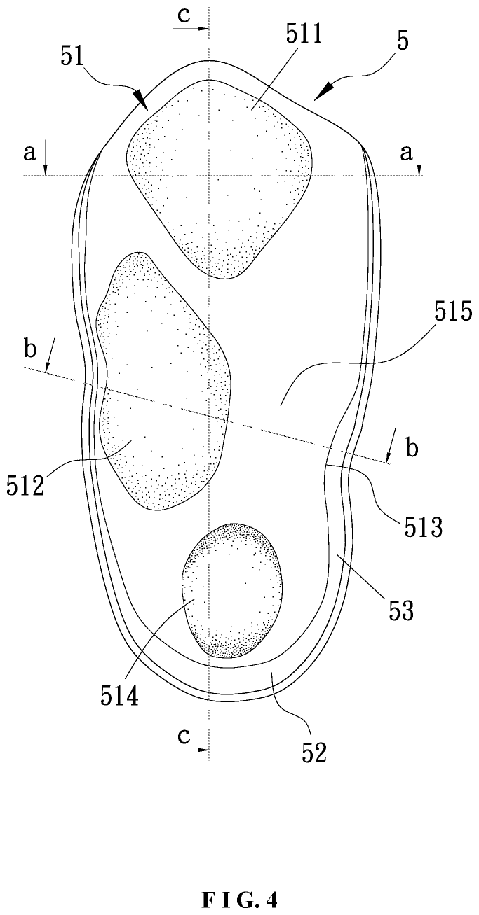

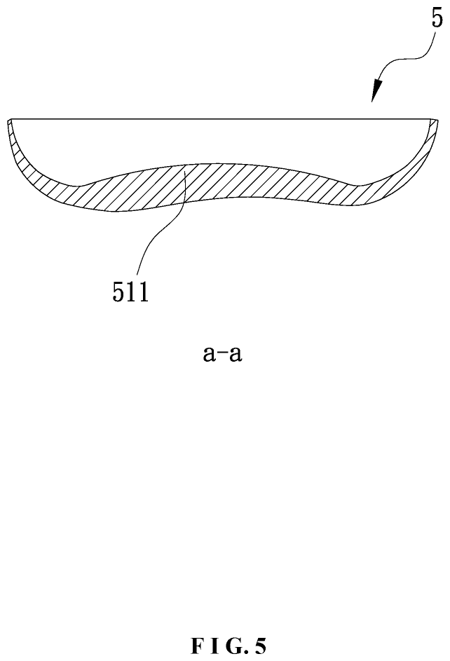

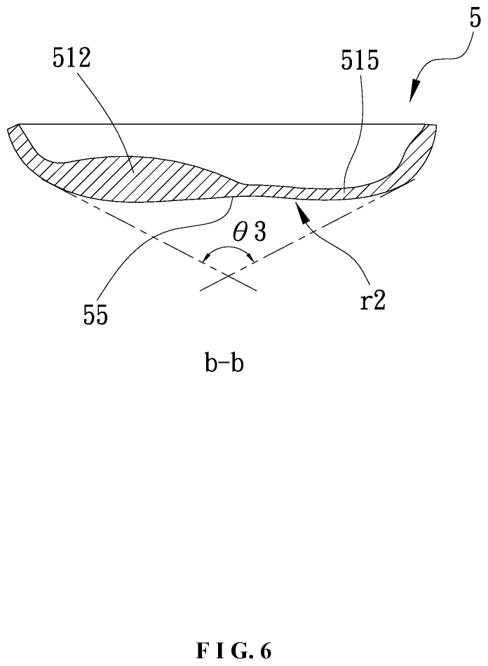

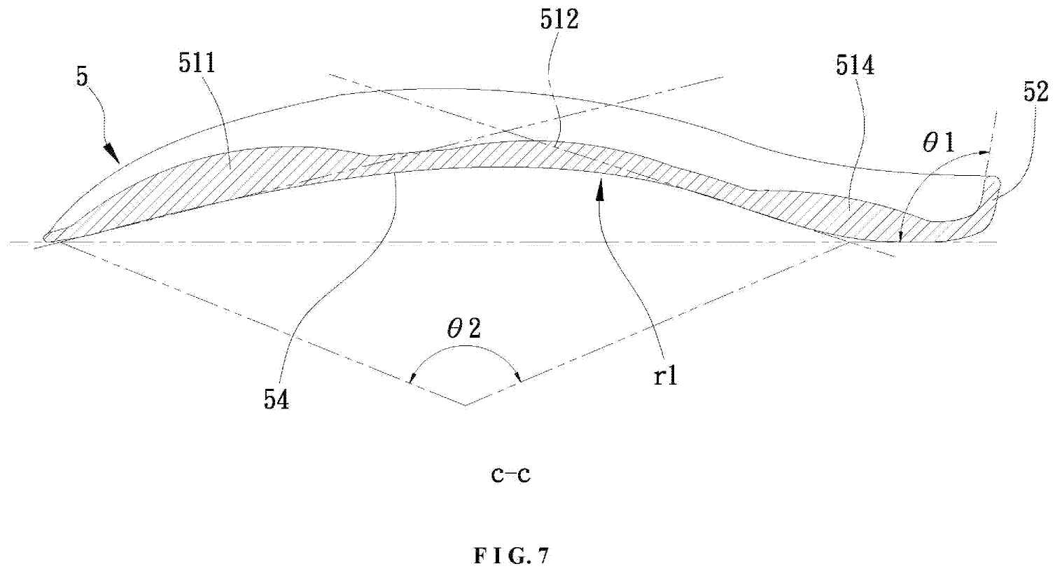

The second step is hot pressing (B), which involves placing the cupric-ion-fiber face layer (1), the shock-absorbing layer (2), the support layer (3), and the antibacterial and anti-slip layer (4) that have been stacked into a shoe-pad mold with a predetermined geometric curve that fits a human transverse-longitudinal foot arch and performing hot pressing thereon, so as to laminate the cupric-ion-fiber face layer (1), the shock-absorbing layer (2), the support layer (3), and the antibacterial and anti-slip layer (4) into a laminate during the hot pressing, thereby forming the shoe-pad (5) that well fits a human foot, wherein as shown in FIG. 4 through FIG. 7, the shoe-pad (5) is formed with a plurality of support zones (51), a heel enclosure (52) raised upward from the rear end of the shoe-pad (5), and an extension segment (53) formed at the outer side of the shoe-pad (5) and connected to the heel enclosure (52), in which the plural support zones (51) include a transverse arch support zone (511), a medial longitudinal arch support zone (512), a lateral longitudinal arch support zone (513), a calcaneus support zone (514), and a transverse-longitudinal support zone (515) that correspond to the transverse arch portion, the medial longitudinal arch portion, the lateral longitudinal arch portion, the calcaneus portion, and the transverse-longitudinal arch portion of a human foot, respectively.

Therein, the hot pressing for the transverse arch support zone (511), the medial longitudinal arch support zone (512), the lateral longitudinal arch support zone (513), and the calcaneus support zone (514) of the support zones (51) is performed at a temperature of 70° C., and the hot pressing for the transverse-longitudinal support zone (515) is performed at a temperature of 100° C. Besides, the hot pressing for the heel enclosure (52) and the extension segment (53) is performed at a temperature of about 165° C. The heel enclosure (52) and the extension segment (53) each have a height of about 15 mm, and the heel enclosure (52) is slightly inclined backward for a backward inclination angle[θ1]of about 100 degrees. Moreover, the shoe-pad (5) is at its bottom formed with a longitudinal support curve (54) that longitudinally extends across the transverse arch support zone (511), the medial longitudinal arch support zone (512), and the calcaneus support zone (514), and a transverse support curve (55) that transversely extends across the medial longitudinal arch support zone (512) and the transverse-longitudinal support zone (515).

The longitudinal support curve (54) has a curve angle[θ2]of about 135 degrees and a radius of curvature [r1] of about 160 to 320 mm. The transverse support curve (55) has a curve angle[θ3]of about 125 degrees and a radius of curvature [r2] of about 60 to 120 mm.

At the third step, finishing (C), the multi-function shoe-pad (5) is finished as the laminate of the cupric-ion-fiber face layer (1), the shock-absorbing layer (2), the support layer (3), and the antibacterial and anti-slip layer (4) so that the shoe-pad (5) can provide antibacterial and foot corrective effects.

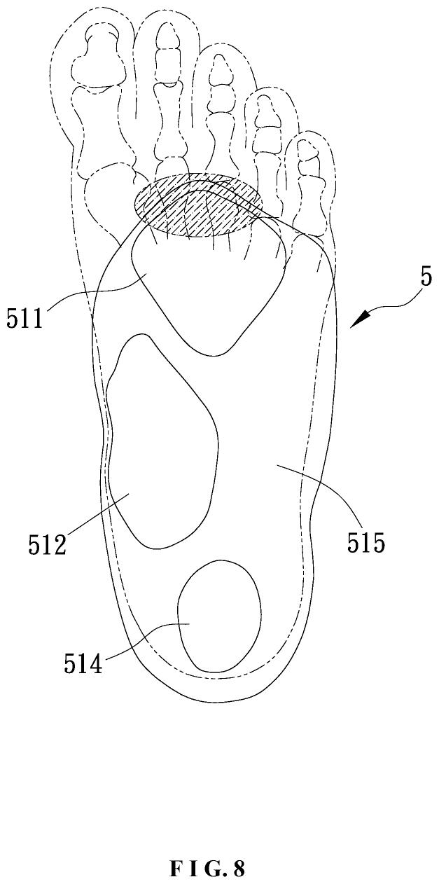

In use, the shoe-pad (5) is placed in a shoe for a user wearing the shoe to stand thereon. As shown in FIG. 8, the transverse arch support zone (511), the medial longitudinal arch support zone (512), the lateral longitudinal arch support zone (513), the calcaneus support zone (514), and the transverse-longitudinal support zone (515) formed on the shoe-pad (5) are designed to well support the transverse arch portion, the metatarsus, the medial longitudinal arch portion, the lateral longitudinal arch portion, the calcaneus portion, and the transverse-longitudinal arch portion of a human foot, and are adapted to bone alignment and bone morphology of a human foot for good corrective, balancing and stabilizing effects. Furthermore, the shoe-pad (5) has a heel enclosure (52) as high as 15 mm, which is 7 mm higher than the heel enclosure of the prior-art shoe-pad as disclosed in Taiwan Patent No. I377919. In addition, with the backward inclination angle of 100 degrees, the heel enclosure (52) supports the heel and the ankle stably, thereby preventing the foot from under pronation and over pronation, and helping to improve endurance of the user for prolonged standing and walking. Moreover, the extension segment (53) located at the outer side of the shoe-pad (5) provides particular support to the pressure area at the lateral longitudinal arch when the foot performs movements, so that the pressure can be distributed to other foot arches. Additionally, the longitudinal support curve (54) and the transverse support curve (55) at the bottom of the shoe-pad (5) jointly form an extensive arch-supporting stereo-curve that makes the shoe-pad (5) more resilient, and more capable of absorbing shock, distributing pressure, and dispersing the ground reaction force, while helping to prevent under pronation and over pronation of the foot during prolonged standing and walking.

Apart from these, the cupric-ion-fiber face layer (1) at the top of the shoe-pad (5) when contacting the human foot can change the charge state of bacteria and fungus with the cupric ions it releases, and thereby break cell walls of bacteria and fungus, so as to provide long-lasting antibacterial and anti-odor effects. The antibacterial and anti-slip layer (4) at the bottom of the shoe-pad (5) serves to stabilize contact between the shoe-pad (5) and the shoe and improve user comfort by preventing the shoe-pad (5) from undesirably shifting in the shoe when the user stands and walks. Besides, since the antibacterial and anti-slip layer (4) contains an antibacterial substance, it can further prevent growth of bacteria in the shoe. Moreover, in the shoe-pad (5), the cupric-ion-fiber face layer (1), the shock-absorbing layer (2), the support layer (3), and the antibacterial and anti-slip layer (4) are laminated together through hot pressing, so the firm combination of the layers is ensured even when being pressed and twisted during walking, speed walking, and prolonged standing. This eliminates the risk of delamination at the periphery of the shoe-pad (5) even after long use. Furthermore, the surface fabric materials of the cupric-ion-fiber face layer (1) and the antibacterial and anti-slip layer (4) are highly wear-proof. With all these advantages, the service life of the shoe-pad (5) is improved.

Given the foregoing configurations and implementations, the present invention has the following benefits:

1. The cupric-ion-fiber face layer at the top of the shoe-pad when contacting the human foot can change the charge state of bacteria and fungus with the cupric ions it releases, and thereby break cell walls of bacteria and fungus, so as to provide long-lasting antibacterial and anti-odor effects, thereby preventing fungus and bacteria from growing on the foot and spreading into living spaces to become serious threat to human health.

2. In the shoe-pad, the cupric-ion-fiber face layer, the shock-absorbing layer, the support layer, and the antibacterial and anti-slip layer are laminated together through hot pressing at high temperatures. This eliminates the risk of breakage and delamination at the periphery of the shoe-pad even after long normal use. Furthermore, the surface fabric materials of the cupric-ion-fiber face layer and the antibacterial and anti-slip layer are highly wear-proof. Thereby, the service life of the shoe-pad is improved.

3. The shoe-pad of the present invention has its rear end formed with the heel enclosure that is high enough and properly inclined backward, so it can support the heel and the ankle stably, thereby preventing the foot from under pronation and over pronation, and helping to improve endurance of the user for prolonged standing and walking. Moreover, the extension segment located at the outer side of the shoe-pad provides particular support to the pressure area at the lateral longitudinal arch when the foot performs movements, so that the pressure can be distributed to other foot arches, thereby achieving good protective and supportive performance.

4. The longitudinal support curve and the transverse support curve at the bottom of the shoe-pad jointly form an extensive arch-supporting stereo-curve that makes the shoe-pad more resilient, and more capable of absorbing shock, distributing pressure, and dispersing the ground reaction force, while helping to prevent under pronation and over pronation of the foot during prolonged standing and walking.

5. The plural support zones of the shoe-pad, including the transverse arch support zone, the medial longitudinal arch support zone, the lateral longitudinal arch support zone, the calcaneus support zone, and the transverse-longitudinal support zone, are designed to well support the transverse arch portion, the metatarsus, the medial longitudinal arch portion, the lateral longitudinal arch portion, the calcaneus portion, and the transverse-longitudinal arch portion of a human foot, and are designed to correct and restore normal bone alignment and bone morphology, thereby providing good balancing and stabilizing effects.

6. The antibacterial and anti-slip layer at the bottom of the shoe-pad serves to stabilize contact between the shoe-pad and the shoe and improve user comfort by preventing the shoe-pad from undesirably shifting in the shoe. Also, the antibacterial properties of the cupric-ion-fiber face layer can inhibit growth of fungus on the foot in the shoe, thereby further enhancing bacteriostasis.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

To sum up, the foregoing embodiments do achieve the objectives of the present invention, and the disclosed configurations have neither been seen in like products nor been published before the filling of the present application, so the present invention is believed patentable by law. The inventor thus respectfully requests for the grant of patent rights thereto.

What is claimed is:

1. An antibacterial cupric-ion-fiber corrective shoe-pad, comprising a cupric-ion-fiber face layer, a shock-absorbing layer, a support layer, and an antibacterial and anti-slip layer, wherein the cupric-ion-fiber face layer, the shock-absorbing layer, the support layer, and the antibacterial and anti-slip layer are vertically stacked in order and laminated into a laminate through hot pressing.

2. The shoe-pad of claim 1, further comprising a plurality of support zones formed thereon, a heel enclosure raised upward from a rear end of the shoe-pad, and an extension segment located at an outer side of the shoe-pad and connected to the heel enclosure.

3. The shoe-pad of claim 2, wherein the heel enclosure has a height of 15 mm.

4. The shoe-pad of claim 2, wherein the plural support zones include a transverse arch support zone, a medial longitudinal arch support zone, a lateral longitudinal arch support zone, a calcaneus support zone, and a transverse-longitudinal support zone located to correspond to a transverse arch portion, a medial longitudinal arch portion, a lateral longitudinal arch portion, a calcaneus portion, and a transverse-longitudinal arch portion of a human foot.

5. The shoe-pad of claim 4, further comprising a bottom formed with a longitudinal support curve that longitudinally extends across the transverse arch support zone, the medial longitudinal arch support zone, and the calcaneus support zone, and a transverse support curve that transversely extends across the medial longitudinal arch support zone and the transverse-longitudinal support zone.

6. A manufacturing method of an antibacterial cupric-ion-fiber corrective shoe-pad, comprising steps of:
A. Stacking: stacking a cupric-ion-fiber face layer, a shock-absorbing layer, a support layer, and an antibacterial and anti-slip layer, each preformed to have a shape of the shoe-pad, vertically in an order from top to bottom;
B. Hot Pressing: placing the cupric-ion-fiber face layer, the shock-absorbing layer, the support layer, and the antibacterial and anti-slip layer that have been stacked into a shoe-pad mold and performing hot pressing thereon, so as to laminate the cupric-ion-fiber face layer, the shock-absorbing layer, the support layer, and the antibacterial and anti-slip layer into a laminate during the hot pressing; and
C. Finishing: finishing the laminate of the cupric-ion-fiber face layer, the shock-absorbing layer, the support layer, and the antibacterial and anti-slip layer into the shoe-pad.

7. The manufacturing method of claim 6, wherein the shoe-pad is further formed with a plurality of support zones, a heel enclosure raised upward from a rear end of the shoe-pad, and an extension segment located at an outer side of the shoe-pad and connected to the heel enclosure.

8. The manufacturing method of claim 7, wherein the plural support zones include a transverse arch support zone, a medial longitudinal arch support zone, a lateral longitudinal arch support zone, a calcaneus support zone, and a transverse-longitudinal support zone located to correspond to a transverse arch portion, a medial longitudinal arch portion, a lateral longitudinal arch portion, a calcaneus portion, and a transverse-longitudinal arch portion of a human foot.

9. The manufacturing method of claim 8, wherein the hot pressing for the transverse arch support zone, the medial longitudinal arch support zone, the lateral longitudinal arch support zone, and the calcaneus support zone is performed at a temperature of 70° C., and the hot pressing for the transverse-longitudinal support zone is performed at a temperature of 100° C.

10. The manufacturing method of claim 7, wherein the hot pressing for the heel enclosure and the extension segment connected thereto is performed at a temperature of 165° C.
